(19) United States
(12) Patent Application Publication
(10) Pub. No.: US 2003/0127846 A1
(43) Pub. Date: Jul. 10, 2003

(54) Anti-counterfeiting device

(75) Inventor: Alexander Speirs Laurie, Royston (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Scientific Generics Limited, Harston (GB)

(21) Appl. No.: 10/169,733

(22) PCT Filed: Jan. 17, 2001
(86) PCT No.: PCT/GB01/00172

(30) Foreign Application Priority Data
Jan. 17, 2000 (GB) 0001060.3

(51) Int. Cl. B42D 15/00

(52) U.S. Cl. 283/72

(57) ABSTRACT

An anti-counterfeiting device for application to or association with consumer goods to give an indication of authenticity comprises: a substrate (10); a latent image (11) formed on the substrate that becomes visible upon exposure to oxygen; an oxygen-impermeable layer (12) covering the latent image, and means to break the oxygen-impermeable layer. The latent image is preferably formed by printing an oxygen-sensitive colouring material on to the substrate.

The present invention relates to anti-counterfeiting measures and, in particular, to a device that can be applied to or incorporated in consumer goods which gives an indication of authenticity at the point of sale, or close to the point of sale.

Consumer goods such as tobacco products and alcoholic beverages, most especially spirits, are prime targets for counterfeiters because of the high levels of duty which such goods attract. This means that the counterfeiters are able to supply a lucrative black market without having to pay the duty, yet still return a sizeable profit even though the selling price of the counterfeit goods is less than that of the genuine article. There is also a significant counterfeit trade in designer clothing and fashion accessories. Clearly, the original manufacturers of such goods would like to preserve for the genuine article the get-up, package design, logo or other distinguishing feature that identifies them as authentic proprietary goods.

In many cases, the counterfeiters are not sophisticated and do not necessarily have access to factory premises for carrying out their illegal business. Forgeries may be created in private dwellings so, if measures are taken to make the task of counterfeiting more onerous, some would-be counterfeiters will simply give up or perhaps look for another opportunity with a less well-protected target.

The present invention is therefore intended to increase the complexity that would be entailed in producing counterfeit goods, using techniques that are relatively cheap and simple to implement on an industrial scale, but uneconomic and complex to implement on a smaller scale, say in a domestic environment rather than a factory set-up. The present invention does not purport to be the ultimate solution to counterfeiting, but is a measure which manufacturers can implement to increase the height of the authenticity barrier, with the aim of deterring at least a proportion of would-be forgers.

The invention uses, for the first time in an anti-counterfeiting measure, the principle of oxidative colour change which may be applied to items such as tear tabs, packaging, shrink wrapping, garment labels, or any other device associated with goods at the point of sale. This means that the goods can be checked in the presence of the retailer to ensure that both the retailer and the consumer are satisfied as to their authenticity.

In recognition of the fact that consumers are not especially patient once they have made a decision to purchase goods, the anti-counterfeiting device of the present invention should ideally give the required visual indication of authenticity within a short period of time, preferably no longer than one minute and most preferably within a matter of seconds. Also, to be a useful anti-counterfeiting measure, the device should be such that no consumer education is required; a device that is integrated with the pack and which actuates upon normal opening of the pack would be regarded as ideal.

The invention is an anti-counterfeiting device comprising:

a substrate;

a latent image formed on the substrate that becomes visible upon exposure to oxygen;

an oxygen-impermeable layer covering the latent image, and

means to break the oxygen-impermeable layer.

The act of breaking the oxygen-impermeable layer means that atmospheric oxygen is allowed access to the latent image and develops it by causing a colour change. The latent image may take any suitable form and can be a word or symbol or graphic representation of some kind, perhaps a rendition of a manufacturer's logo. In its simplest form, the latent image is developed to a single colour, but multiple coloured developed images are also to be regarded as falling within the scope of the present invention.

The latent image is formed from any suitable colouring means such as a pigment or dye that is oxygen-sensitive, the main criterion being that it should be colourless or substantially free of colour in its non-oxidised state. The terms “pigment” and “dye” used herein have no special meaning and the skilled reader should apply the normal dictionary definitions to these words. Hence, “pigment” will be understood to mean any substance used to impart colour and “dye” will be taken to mean a staining or colouring substance, including natural and synthetic materials. Preferably, the colouring means is an aromatic organic compound having one or more electron-donating substituents. Most preferably, the colouring means is selected from 1,2,4-trisubstituted benzenes; tetrasubstituted benzenes; di- and tri-substituted pyridines, quinolines or isoquinolines; reduced (or leuco) forms of common textile dyes; and metal chelate systems in which the complex formed by the metal in its higher valency (oxidised) state is coloured, or is at least differently coloured from its lower valency state counterpart. Combinations of the foregoing classes of compounds may also be used. Preferably, the substituents in the substituted aromatic species listed above are selected from hydroxy, methoxy or amino (including N-substituted amino wherein the N-substituents are C₁-C₄ alkyl or C₁-C₄ alkoxy groups).

The oxygen-impermeable layer is most preferably a transparent polymer film having a low permeability to oxygen. Preferred polymers are the higher-melting film-forming polymers such as PET or PEN, but these have an appreciable oxygen permeability in their untreated state so, in practice, they may be augmented with a surface coating of a high performance barrier material such as silicon monoxide (SiOₓ) or amorphous carbon. This coating of barrier material will normally be provided on the surface of the oxygen-impermeable layer that faces the latent image. This is because such coatings are friable and would easily be damaged if provided on the outside of the device, thereby compromising the effectiveness of the oxygen barrier. A typical thickness for the barrier coating would be of the order of 100 Å (10 nm).

The substrate can be formed from any thin film material, for example, polymer film or a porous substrate such as paper, card or even textile. The colour may be selected to provide a strong contrast with the developed colouring material. Alternatively, the substrate may have a print-receptive base layer which provides the necessary contrast with the developed colouring material. The colouring material may be incorporated in a low opacity white pigment compound such as Mg(OH)₂ or BaSO₄, which are commonly used as extenders in printing inks. When the latent image formed by the colouring material is developed, this shows up strongly against the low opacity white background.

If the substrate is not oxygen-impermeable, it needs to be encapsulated to prevent oxygen ingress. The same material is preferably used to encapsulate the substrate that is used to form the oxygen-impermeable barrier covering the latent image. Alternatively, the substrate may be formed from a material that it is inherently impermeable to oxygen, such as a thin metal foil which may be coated or uncoated, a polymer film (for example PET or PEN), coated with a high performance barrier material such as silicon monoxide (SiOₓ) or amorphous carbon.

As mentioned above, an essential component of the anti-counterfeiting device of the present invention is an oxygen sensitive compound that is used for the latent image. The specific compound or compounds used can be selected from several classes of materials, including aromatic organic compounds having at least one electron-donating substituent. The electron-donating substituents increase the electron density of the aromatic system, making it more liable to oxidation. Hence, the more electron-donating substituents that are present, the greater the tendency for rapid oxidation.

Examples of typical auto-oxidative dyes and the colours that their oxidised (developed) forms produce are given below:

COLOURS FROM TRISUBSTITUTED BENZENE
AUTOXIDATIVE DYES

| Substituents | | | |
|---|---|---|---|
| 1 | 2 | 4 | Colour |
| OH | OH | OH | Mid brown |
| OH | OMe | OH | Pink-red |
| NH₂ | NH₂ | OH | Orange |
| NHMe | NH₂ | OH | Red-brown |
| NMe₂ | NH₂ | OH | Grey |
| NH₂ | NHMe | OH | Pink |
| NH₂ | NMe₂ | OH | Khaki |
| NH₂ | NH₂ | OMe | Yellow-orange |
| NH₂ | OH | NH₂ | Purple |
| NH₂ | OH | NHMe | Violet |
| NH₂ | OH | NMe₂ | Blue |
| NHMe | OH | NH₂ | Purple-brown |
| NMe₂ | OH | NH₂ | Beige |
| NH₂ | OMe | NH₂ | Purple-grey |
| OH | NH₂ | NH₂ | Red-brown |
| OH | NH₂ | NHMe | Dark grey |
| OH | NH₂ | NMe₂ | Brown-grey |
| OH | NHMe | NH₂ | Flat brown |
| OH | NMe₂ | NH₂ | Deep brown |
| OMe | NH₂ | NH₂ | Yellow-brown |
| NH₂ | OH | OMe | Orange-brown |

COLOURS FROM TETRASUBSTITUTED BENZENE
AUTOXIDATIVE DYES

| Substituents | | | | | |
|---|---|---|---|---|---|
| 1 | 2 | 3 | 4 | 5 | Colour |
| OH | OH | H | OH | OH | Orange |
| OH | NH₂ | OH | H | OH | Golden brown |
| OH | OH | H | NH₂ | Br | Brown |
| OH | OH | OH | H | NH₂ | Brown |
| NH₂ | OH | NH₂ | H | NMe₂ | Green |
| OH | NH₂ | H | OH | OMe | Orange |
| NH₂ | OH | NH₂ | H | OH | Ash blond |
| NH₂ | OH | NH₂ | H | OMe | Khaki |
| NH₂ | OH | NH₂ | H | NH₂ | Greenish |
| OMe | OH | NH₂ | H | NH₂ | Auburn |
| Br | NH₂ | OH | H | NH₂ | Purple |
| NH₂ | NH₂ | H | NH₂ | OH | Light brown |
| NH₂ | OH | H | NH₂ | OH | Grey |
| NH₂ | OH | H | NH₂ | Me | Royal blue |
| NH₂ | OH | H | NH₂ | OMe | Violet |
| NH₂ | NH₂ | NH₂ | H | NH₂ | Brown |
| NH₂ | NH₂ | H | NH₂ | NH₂ | Yellow-Brown |
| NH₂ | OMe | Me | NH₂ | Me | Violet |

COLOURS FROM QUINOLINE AUTOXIDATIVE DYES

| Substituents | | | |
|---|---|---|---|
| 5 | 6 | 8 | Colour |
| OH | OH | OH | Orange-brown |
| OH | OMe | OH | Light brown |
| OH | NH₂ | NH₂ | Brown |
| NH₂ | OMe | NH₂ | Grey |
| 5 | 7 | 8 | |
| NH₂ | NH₂ | OH | Red-brown |
| 2 | 4 | 6 | |
| OH | OH | NH₂ | Violet |

Pyridine Derivatives

5-amino-3-hydroxy pyridine
2-amino-3-hydroxy pyridine
3-amino-2-hydroxy pyridine
5-amino-2-hydroxy pyridine
4-amino-2-hydroxy pyridine
2-methoxy-3-amino pyridine
2-methoxy-5-amino pyridine
2-ethoxy-3-amino pyridine

Reduced (leuco) dye systems
Methylene Blue, Thionine, Azure B, Azure C, Neomethylene
Blue, Brilliant Alizarin Blue, Lauth's Violet, Acid Red
and Indigocarmine

COLOURS PRODUCED BY METAL CHELATE DYES

| Chelating Agent | Metal ion | Colour |
|---|---|---|
| Dithiooxamide | Ni²⁺ | Blue |
| | Cu²⁺ | Grey-green |
| | Co²⁺ | Orange-brown |
| N,N′-Dimethyldithiooxamide | Ni²⁺ | Red |
| Diethyldithiocarbamate | Cu²⁺ | Golden-brown |
| Dithiooxamide + | Cu²⁺ | Black |
| ethylenediamine | | |
| Ammonium thioglycollate | Ni²⁺ | Red-brown |
| 1,8-Phenanthroline | Fe²⁺ | Orange |
| 2,2′-Bipyridyl | Fe²⁺ | Red |
| 2,5-Tris-2′-pyridyltriazine | Fe²⁺ | Blue |
| 2-Acetylpyridine | Cu²⁺ | Yellow |
| methylhydrazone | | |
| 2-Acetylpyridine-2′-pyridyl- | Co²⁺ | Red |
| hydrazone | | |
| 2-Quinolinealdehyde-2′- | Co²⁺ | Lilac |
| quinolinyl hydrazone | | |

Each of the above compounds is capable of undergoing a colour transition when exposed to oxygen. Typically, the colour transition is from a colourless, or near-colourless, state to a much more strongly coloured condition which is denoted in this document as the developed form. Used in this way, the individual compounds are useful in revealing a simple monochrome legend. However, by using a combination of such dye precursors, printed in specific patterns in relation to each other, it is possible to create a more complex image, such as a logo or a design with some graphic content. Moreover, by careful selection of materials which interact in the same way as conventional process inks, it is possible to create full colour images of photographic quality.

The materials exemplified above do not all have the same physical state—some are liquids and others are solids. In their native form, it is unlikely that they are ideally suited to the printing process. It is envisaged that the active agents will therefore be incorporated into a printable vehicle. Suitable formulations will typically comprise a solvent, diluent and a film forming polymer. The concentration of the polymer component should be kept as low as practicable and, optionally, to improve machine handling, an inert filler such as magnesium carbonate or barium sulphate can be added.

Conveniently, the anti-counterfeiting device of the present invention is constructed as a laminated article. The laminate comprises the substrate on which the latent image is formed and the colouring means used to form the latent image is preferably deposited onto the substrate using a conventional web-based printing process, such as gravure, flexography or a non-contact process such as ink-jet printing. This may be continuous or on-demand ink-jet printing. After printing, the substrate is then incorporated into a laminated structure such that the oxygen-sensitive component is isolated from the atmosphere. This requires that the printing operation and/or other processes up to the lamination step are completed under an inert atmosphere, which may be nitrogen for example. The main criterion for inertness is that oxygen levels should be negligible.

As indicated above, the material used for the substrate may be an oxygen-impermeable material, which means that it can form one face of the laminated article. Alternatively, if the substrate is porous or oxygen-permeable, it will need to be encapsulated in the lamination process. Most conveniently, the same material is used to cover the reverse side of the substrate as that which is used to cover the surface of the substrate having the image-forming colouring means.

The lamination process may be effected by heat sealing or radio frequency welding. The laminated article is stable and can be attached to any product which requires proof of authenticity or in circumstances where counterfeiting is a concern. The laminated article can be configured as a tear tape, a label, a tamper-proof band or a shrink sleeve, depending on how it can best be attached to or associated with the product which it is intended to protect.

Ideally, activation of the anti-counterfeiting device will be intuitive for the consumer and, for this reason, is best associated with the action of opening the packaging. In practice, the laminate must either be cut, torn or peeled apart, thereby allowing atmospheric oxygen to initiate the colour change. Some assistance for the consumer can be provided here by integrating a tear tape or tab into the laminated structure, or by laser scribing a weakened area which will tear or part readily.

In circumstances requiring extreme stability, or where shelf life or the distribution process is of long duration, it is possible to incorporate an oxygen scavenger into the laminate that acts to remove any oxygen which permeates into the structure. Suitable oxygen scavengers are commercially available and are typically based on ferrous oxide. It is also possible to incorporate a stabiliser in the colouring material to attenuate its reactivity and slow down the rate of colour development once exposure to oxygen has occurred.

The invention will now be described by way of example with reference to the drawings, in which:

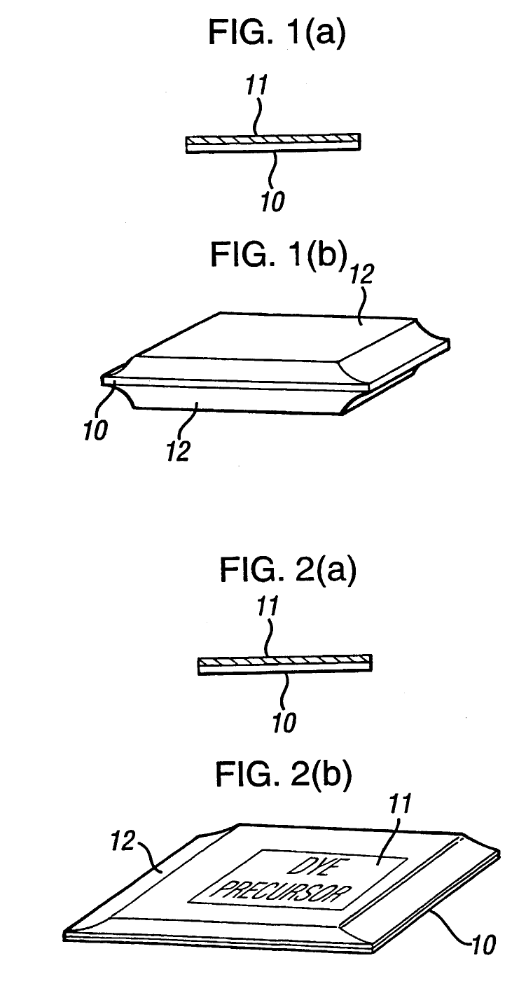

FIG. 1 is a schematic representation of a first embodiment of an anti-counterfeiting device in accordance with the present invention;

FIG. 2 is a schematic representation of a second embodiment of an anti-counterfeiting device in accordance with the present invention;

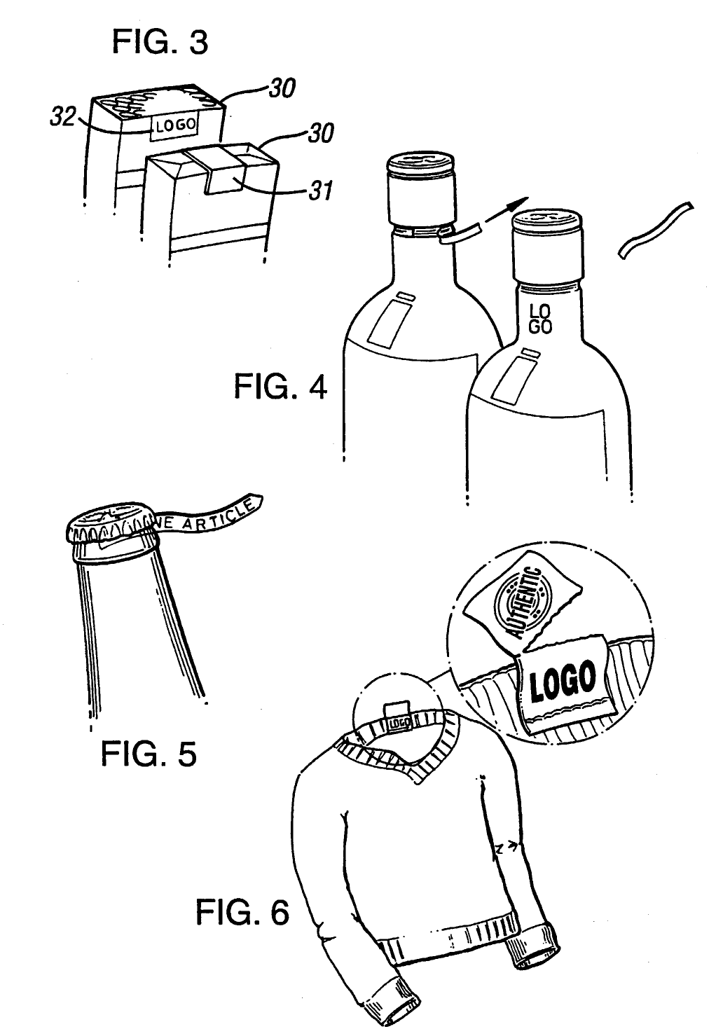

FIG. 3 is a schematic perspective view of an anti-counterfeiting device applied to a packet of cigarettes;

FIG. 4 is a schematic perspective view of an anti-counterfeiting device associated with a bottle of spirits;

FIG. 5 is a schematic perspective view of anti-counterfeiting device associated with a bottle sealed by a crown cork, and

FIG. 6 is a schematic perspective view of anti-counterfeiting device incorporated as part of a garment label.

Referring firstly to FIG. 1, view (a) shows a cross-sectional view of a substrate 10 formed of a porous material such as paper, card or textile fabric. Applied to one surface of the substrate 10 is a pattern of colouring material in the form of a dye precursor 11 that forms a latent image on the substrate 10. The thickness of the pattern 11 is shown greatly exaggerated in this view for the purposes of clarity.

Because the substrate 10 is porous, it needs to be covered with an oxygen-impermeable layer on both faces, that is to say on the face having the pattern 11, as well as the non-patterned face.

View (b) shows a perspective view of an assembled laminate comprising the component depicted in view (a) after encapsulation between two layers of an oxygen barrier film 12. Encapsulation may be effected by means of heat sealing or radio frequency welding.

In FIG. 2, a similar arrangement is shown as in view 1(a), but this time a non-porous substrate material 10 has been used. The substrate in this embodiment may be, for example, a thin aluminium foil free of pin-holes.

Because of the impervious nature of the substrate 10, only one face of the substrate 10 needs to be protected with an oxygen barrier film 12. View (b) shows in perspective an example of a completed laminated having only one layer 12 of an oxygen-impermeable film attached by heat sealing or radio frequency welding to the face of the substrate 10 that bears the pattern 11.

FIG. 3 shows how the anti-counterfeiting device of the present invention can be applied to a packet of cigarettes 30. An indicating panel or strip 31 is incorporated into the clear overwrap that is used as part of the packaging. When the consumer opens the pack in the normal way, the strip 31 is lifted to activate the device. Upon exposure to atmospheric oxygen, a design 32 is developed in a short space of time that confirms the authenticity of the goods. The design 32 may be, for example, the brand name of the cigarettes or the manufacturer's logo.

An example of a suitable material for effecting a noticeable colour change is 4-amino-3,6-dihydroxy pyridine which changes from colourless to black upon oxidation.

Similarly, as shown in FIG. 4, removal of a tear band at the base of a foil cap on a bottle of spirits can be used to allow oxygen ingress to an anti-counterfeiting shrink sleeve provided around the neck of the bottle. When oxygen is admitted to the latent image provided on an underlayer of the sleeve, a coloured pattern develops testifying to the authenticity of the spirit goods.

In similar vein, a sealing strip can be provided around the base of a crown cork, as depicted in FIG. 5. When this is removed, oxygen is admitted and an image is developed which confirms the authenticity of the product.

In FIG. 6, the anti-counterfeiting device of the present invention is shown incorporated into a garment label. A tear-off portion is included as part of the label and, when this is removed, oxygen is allowed to permeate into the label and causes the development of an image which confirms the authenticity of the goods. The label may be constructed with a latent image on the tear-off portion, or on the portion which remains attached to the garment, or both.

Although not illustrated in the drawings, it is also possible to have a large label with a number of tear-off patches each of which can be removed by successive would-be purchasers to testify to the authenticity of the goods.

Although the invention has been described above with reference to particular embodiments, it will be understood by persons skilled in the art that variations and modifications are possible without departing from the scope of the claims which follow.

1. Use of an anticounterfeit device in which the anticounterfeit device is attached to goods to be sold, which anticounterfeiting device comprises an oxygen-impermeable laminated article capable of attachment to the goods and comprising
(a) a substrate;
(b) a latent image formed on the substrate that becomes visible upon exposure to oxygen and identifying the source of the goods;
(c) an oxygen-impermeable layer covering the latent image and, where the substrate is oxygen-permeable, additionally encapsulating the substrate, whereby the oxygen-impermeable layer, either alone or together with an oxygen-impermeable said substrate, provides a seal preventing ingress of oxygen to the latent image; and which device further comprises
(d) means allowing breakage of the seal provided by the oxygen-impermeable layer so as to allow exposure of the latent image to oxygen and thereby generate the image identifying the original source of the goods.

2. Use according to claim 1, wherein the substrate is oxygen-impermeable and the oxygen-impermeable layer is sealed to the substrate around the latent image.

3. Use according to claim 2, wherein the substrate is selected from a metal foil and an oxygen-impermeable polymer film.

4. Use according to claim 1, wherein the substrate is oxygen-permeable and the oxygen-impermeable layer encapsulates the substrate.

5. Use according to claim 4, wherein the substrate is selected from an oxygen-permeable polymer film, paper, card and textile material.

6. Use according to any preceding claim, wherein the laminated article is selected from a tear tape, a label, a tamper-proof band and a shrink sleeve.

7. Use according to claim 6, wherein the laminated article is selected from a tear tape, a label and a tamper-proof band.

8. Use according to claim 7, wherein the substrate is a textile material and the laminated article is a garment label.

9. Use according to any preceding claim, wherein the latent image is formed using a colourless substrate capable of oxidation by oxygen to provide a coloured. substrate.

10. Use according to claim 9, wherein the oxygen-sensitive colouring means is selected from aromatic organic compounds having at least one electron-donating substituent; leuco dyes; and metal chelate systems; and combinations thereof.

11. Use according to claim 10, wherein the aromatic organic compound is at least one of a 1,2,4-trisubstituted benzene; a tetrasubstituted benzene; a disubstituted pyridine, quinoline or isoquinoline; a trisubstituted pyridine, quinoline or isoquinoline; or a combination thereof.

12. Use according to any preceding claim, wherein the oxygen-impermeable layer is a transparent polymer film.

13. Use according to claim 12, wherein the oxygen-impermeable layer is selected from PET and PEN.

14. Use according to claim 12 or claim 13, wherein the oxygen-impermeable layer has thereon a surface coating of a barrier material selected from silicon oxide (SiOₓ) and amorphous carbon.

15. Use according to any preceding claim, wherein the laminated article includes an oxygen scavenger between the oxygen-impermeable layer and the substrate.

16. Use according to claim 15, wherein the scavenger is ferrous oxide.

17. Use according to any preceding claim, wherein the means allowing breakage of the seal is a weakened portion of the laminate capable of facilitating breakage to admit ingress of atmospheric oxygen.

18. A method of deterring counterfeit by allowing a consumer of goods to determine their original source, in which there is attached to the goods an anticounterfeiting device, which anticounterfeiting device comprises an oxygen-impermeable laminated article capable of attachment to the goods and comprising
(a) a substrate;
(b) a latent image formed on the substrate that becomes visible upon exposure to oxygen and identifying the source of the goods;
(c) an oxygen-impermeable layer covering the latent image and, where the substrate is oxygen-permeable, additionally encapsulating layer covering the substrate, whereby the oxygen-impermeable layer, either alone or together with an oxygen-impermeable said substrate, provides a seal preventing ingress of oxygen to the latent image; and which device further comprises
(d) means allowing breakage of the seal provided by the oxygen-impermeable layer so as to allow exposure of the latent image to oxygen and thereby generate the image identifying the original source of the goods.

19. A method according to claim 18, wherein the substrate is oxygen-impermeable and the oxygen-impermeable layer is sealed to the substrate around the latent image.

20. A method according to claim 19, wherein the substrate is selected from a metal foil and an oxygen-impermeable polymer film.

21. A method according to claim 18, wherein the substrate is oxygen-permeable and the oxygen-impermeable layer encapsulates the substrate.

22. A method according to claim 2, wherein the substrate is selected from an oxygen-permeable polymer film, paper, card and textile material.

23. A method according to any one of claims 18 to 22, wherein the laminated article is selected from a tear tape, a label, a tamper-proof band and a shrink sleeve.

24. A method according to claim 23, wherein the laminated article is selected from a tear tape, a label and a tamper-proof band.

25. A method according to claim 24, wherein the substrate is a textile material and the laminated article is a garment label.

26. A method according to any of claims 18 to 25, wherein the latent image is formed using a colourless substrate capable of oxidation by oxygen to provide a coloured substrate.

27. A method according to claim 26, wherein the oxygen-sensitive colouring means is selected from aromatic organic compounds having at least one electron-donating substituent; leuco dyes; and metal chelate systems; and combinations thereof.

28. A method according to claim 27, wherein the aromatic organic compound is at least one of a 1,2,4-trisubstituted benzene; a tetrasubstituted benzene; a disbustituted pyridine, quinoline or isoquinoline; a trisubstituted pyridine, quinoline or isoquinoline; or a combination thereof.

29. A method according to any one of claims 18 to 28, wherein the oxygen-impermeable layer is a transparent polymer film.

30. A method according to claim 29, wherein the oxygen-impermeable layer is selected from PET and PEN.

31. A method according to claim 29 or claim 30, wherein the oxygen-impermeable layer has thereon a surface coating of a barrier material selected from silicon oxide (SiOₓ) and amorphous carbon.

32. A method according to any one of claims 18 to 31, includes an oxygen scavenger between the oxygen-impermeable layer and the substrate.

33. A method according to claim 32, wherein the scavenger is ferrous oxide.

34. A method according to any one of claims 18 to 33, wherein the means allowing breakage of the seal is a weakened portion of the laminate capable of facilitating breakage to admit ingress of atmospheric oxygen.

35. An anticounterfeiting device, comprising a one-piece oxygen-impermeable laminated article selected from a tear tape, label and tamper-proof band capable of attachment to a product requiring proof of authenticity and comprising
(a) a substrate;
(b) a latent image formed on the substrate that becomes visible upon exposure to oxygen and identifying the source of the goods;
(c) an oxygen-impermeable layer covering the latent image and, where the substrate is oxygen permeable, additionally encapsulating the substrate, whereby the oxygen-impermeable layer, either alone or together with an oxygen-impermeable said substrate, provides a seal preventing ingress of oxygen to the latent image; and which device further comprises
(d) means allowing breakage of the seal provided by the oxygen-impermeable layer so as to allow exposure of the latent image to oxygen and thereby generate the image identifying the original source of the goods.

36. A claim according to claim 35, wherein the substrate is oxygen-impermeable and the oxygen-impermeable layer is sealed to the substrate around the latent image.

37. A device according to claim 36, wherein the substrate is selected from a metal foil and an oxygen-impermeable polymer film.

38. A device according to claim 35, wherein the substrate is oxygen-permeable and the oxygen-impermeable layer encapsulates the substrate.

39. A device according to claim 38, wherein the substrate is selected from an oxygen-permeable polymer film, paper, card and textile material.

40. A device according to any one of claims 35 to 39, wherein the substrate is a textile material and the laminated article is a garment label.

41. A device according to any one of claims 35 to 40, wherein the latent image is formed using a colourless substrate capable of oxidation by oxygen to provide a coloured substrate.

42. A device according to claim 41, wherein the oxygen-sensitive colouring means is selected from aromatic organic compounds having at least one electron-donating substituent; leuco dyes; and metal chelate systems; and combinations thereof.

43. A device according to claim 42, wherein the aromatic organic compound is at least one of a 1,2,4-trisubstituted benzene; a tetrasubstituted benzene; a disubstituted pyridine, quinoline or isoquinoline; a trisubstituted pyridine, quinoline or isoquinoline; or a combination thereof.

44. A device according to any one of claims 35 to 43, wherein the oxygen-impermeable layer is a transparent polymer film.

45. A device according to claim 44, wherein the oxygen-impermeable layer is selected from PET and PEN.

46. A device according to claim 44 or claim 45, wherein the oxygen-impermeable layer has thereon a surface coating of a barrier material selected from silicon oxide (SiOₓ) and amorphous carbon.

47. A device according to any one of claims 35 to 46, includes an oxygen scavenger between the oxygen-impermeable layer and the substrate.

48. A device according to claim 47, wherein the scavenger is ferrous oxide.

49. A device according to any one of claims 35 to 48, wherein the means allowing breakage of the seal is a weakened portion of the laminate capable of facilitating breakage to admit ingress of atmospheric oxygen.
